(19) United States
(12) Patent Application Publication
(10) Pub. No.: US 2024/0241260 A1
(43) Pub. Date: Jul. 18, 2024

(54) 3D IMAGE DETECTION AND RELATED 3D IMAGING SENSORS

(71) Applicant: FASTREE3D SA, Ecublens (CH)

(72) Inventors: Francesco CARUSO, Lausanne (CH); Lucio CARRARA, Penthaz (CH)

(21) Appl. No.: 18/563,248

(22) PCT Filed: Jun. 2, 2021
(86) PCT No.: PCT/EP2021/064768

§ 371 Date: Nov. 21, 2023

(51) Int. Cl. G01S 17/894; G01S 7/4863; G01S 7/4865

(52) U.S. Cl. CPC G01S 17/894; G01S 7/4863; G01S 7/4865

(57) ABSTRACT

A method of determining 3D information of a target includes emitting a light pulse and detecting a first incident photon by a detector element. The time of incidence of the detection of the first incident photon is determined and at the incidence time, a time window is opened with a predetermined duration. All the photons detected in the window are associated with the time of incidence detection of the first incident photon. The cycle is repeated and further first incident photons open another time window so that to each of the individual detector elements that detect further incident photons in the time windows, other incidence times are associated. The time difference between the received photons and the emitted pulse is determined and new cycles of detecting first incident photons and the opening of a new time window are repeated and 3D information of the target is provided.

### TECHNICAL FIELD

The present invention relates to the field of 3D image sensors and LIDAR imagers. More precisely the invention relates to methods and 3D imaging systems requiring detectors having a very high number of pixels and for the detection of short inter-arrival time photons when operated under strong background illumination and fast changing environments. More particularly, the invention relates to 3D imaging systems and LIDARs wherein the signal of interest is a pulsed light beam, for example flashed laser LIDARs for automotive applications.

### BACKGROUND OF THE INVENTION

Systems for creating a 2D and/or 3D representation of a given portion of space have a huge number of potential applications in many different fields. Examples are: automotive sensor technologies, robotic sensor technologies, security applications or general photography. In most of these applications, taking a 2D or a 3D image is difficult when performed under intense background light such as under bright sunlight. In some devices such as 3D imaging systems a depth information is required, and some solutions consist of timing the interval between the emission and the return of a measurement signal. In such time-of-flight (TOF) approaches a scanning light beam or a flash-light beam is used, and a trade-off has to be made between required high power density at the location of distant objects and eye-safety issues at short distances from the light emitter. Eye-safety issues are due to the fact that in the case of optical imaging the measurement consists of light waves in the visible (VIS), infrared (IR) or ultraviolet (UV) part of the electromagnetic spectrum, resulting in possible harm to the human retina. In hybrid 2D/3D imagers the 2D image may be made in the visible range and the 3D image may be provided by using for example a pulsed or modulated light source such as an infrared laser. Superimposed on the emitted laser light, the detector normally receives a component of background light that does not bear any information from the scene. The latter, generally referred to as noise, is characterized by a DC contribution and results in a flat portion of the signal on top of the laser-correlated information signal. As a consequence of the presence of noise, the reliability of the measured phase and/or the spatial distribution of the reflected light from an illuminated object may be considerably reduced. Therefore, it is important to find solutions to enhance the image resolution while at the same time suppressing the effect of background light, especially in an environment with fast moving targets.

Increasing the number of pixels in a LIDAR poses a great challenge to the system design. The more pixels are present, the more time to digital converters (TDCs) need to be integrated on a single chip in order to convert the growing amount of timing information, usually requiring a linear increase of consumed power and area. Various architectures have been proposed to contain the number of integrated time to digital converters, typically by sharing a single TDC among a plurality of detectors. These architectures usually come with tight trade-offs between the number of pixels, the pixel's maximum activity rate (defined as the number of detected events per detector per unit of time), and eventual SNR degradation.

For example, in some of these architectures the time to digital conversion is started synchronously with the laser pulse emission (START signal) and stopped as soon as one of the pixels connected to the TDC detects an incoming photon (STOP signal). The first pixel receiving a photon in the detection frame takes over control of the TDC until the emission of a new laser pulse, thus allowing the extraction of only one-time information per cluster of pixels per laser cycle. In this architecture, the photons that come earlier in the measurement cycle have an inherently higher probability of being detected than the photons coming later in time. This approach increases the possibility of detector saturation, especially when many pixels are connected to the same TDC. Moreover, when the LIDAR is operated under strong background illumination (ex: automotive applications) there is a high probability that one of the pixels detects an event due to background light before the actual laser signal is received, blocking the detection of the latter one, and causing the phenomenon of accumulation of noise detected events, known as “pile-up effect”.

Other photon detection systems based on TDC sharing, as for example in some medical applications, make use of a single TDC connected to several detectors to count multiple incoming photons and define an energy barrier. Despite being able to reduce the pile-up and improve the SNR of the measurement, these techniques do not allow to assess the individual arrival time of each detected event in a cycle, and as a result are unsuitable for 3D image reconstruction.

Several techniques exist in literature that can be used to reduce the pile-up when strong background noise is present, for example by coincidence detection or by using rolling gate techniques. Coincidence detection of photons may be successfully used to reduce the amount of noise events with respect to the signal events, helping in the removal of the pile-up and allowing an increase of the SNR. Coincidence detection, however, requires the use of multiple sensors usually arranged within a single pixel cell to produce a single time information, causing an effective loss in area resources. Besides, a strong filtering action of the coincidence might require a long time before allowing the generation of a meaningful histogram (up to seconds depending on the depth of the coincidence that is used or the intensity of the reflected signal), and as a result are not feasible for fast speed changing environments.

Rolling gate or progressive gating are able to reduce the pile-up by splitting the LIDAR measurement range into smaller sub-measurement intervals. However, since the arrival time of the laser signal is not-known a priori, the rolling gate has to cover the entire TDC measurement range, reducing the frame rate by a factor equal to the number of sub-measurements. In addition, only one interval contains the valuable signal information, causing an inevitable loss of signal that can often be unacceptable especially when operating at high frame rate.

### SUMMARY OF THE INVENTION

The present invention proposes a 3D imager and a method to perform 3D images that overcomes the limitations and problems presented by prior art 3D imagers.

The present invention relates to a TDC architecture that is able to detect and extract the arrival time of multiple events in a single laser cycle, without the need to stop the time to digital conversion. The solution of the invention allows to overcome the limit of saturation of the known architectures. The system and its associated method allows to increase the TDC maximum conversion rate and also allows a better sharing of the TDC among the pixels of the detector array of the detector of the 3D imager. As a unique and innovative feature, the architecture of the invention exploits the use of a time window for further improving the time extraction of multiple photons which are very close in time, which is the case for systems that rely on emitted laser light pulses.

It is an object of the present invention to provide an improved method, corresponding imager and electronic circuitry for the realization of a 3D imaging system that can integrate a high number of pixels, and can operate under strong background illumination and fast changing environments, while obtaining an improved SNR compared to methods and devices of prior art.

The method and the device of the invention are especially useful in 3D imagers, such as LIDAR systems, that require a very high number of pixels for the detection of short inter-arrival time photons, such as provided by laser pulses, when operated under strong background illumination and fast changing environments. The invention is particularly suited for flash LIDAR systems for automotive, robotics and machine vision applications.

The invention provides a greater scalability of 3D imagers compared to the systems of prior art. More precisely the method and the system of the invention allows to operate at a very high photon detection rate, overcoming the main drawbacks of the existing solutions such as those that rely on the sharing of a single TDC or other systems of prior art.

In a first aspect the invention is achieved by a method for determining 3D information of a target, the 3D information comprising the distance of multiple points of a target. The method comprises the steps of:
A. providing a 3D imager comprising a sender device and a pulsed light source, and a receiver device. The receiver device comprises a detector comprising a plurality of detector elements;
B. activating said sender device and emitting, at a start time T0, a light pulse;
C. detecting a first incident photon by one of said detector elements;
D. extracting the time of incidence T1 of said first incident photon;
E. opening, at said time of incidence T1, a time window TW having a predetermined duration ΔT;
F. detecting, during said time window TW, further incident photons by said detector and identifying the individual detector elements that have detected said further incident photons;
G. associating, during said time window TW, to each of said individual detector elements that have detected said further incident photons, said time of incidence T1, and closing said time window;
H. extracting the time interval Ti defined by T1−T0.
I. Repeating steps C to H by detecting at each cycle a new first incident photon.
J. Repeating the steps B-I.

In an embodiment the method comprises a step K of providing a 3D image of said target by using the information, provided during said time window TW, of said time of incidence T1 associated to each of said individual detector elements.

In an embodiment the detector elements are single photon detection elements.

In an embodiment the single photon detection elements are single photon avalanche diodes (SPADs).

In an advantageous embodiment the method comprises a step of activating a predetermined number N of detector elements of said detector.

In an embodiment said time window TW is applied only to all of said predetermined number N of detector elements.

In an embodiment the method comprises a step to define the maximal number of incident photons that may be registered during said duration ΔT.

In an embodiment the definition of said maximal number of incident photons may be changed during any one of steps A-J.

In an embodiment the definition of said maximal number of incident photons is depending on internal or external conditions.

In an embodiment wherein said duration ΔT may be changed during any one of steps A-J.

In an embodiment the change of the duration ΔT is depending on internal or external conditions.

In an embodiment said internal conditions are variables of the 3D imager chosen among: the power consumption, the activity of the detector matrix, the temperature, duration of the laser impulse, or a combination of them.

In an embodiment said external conditions are variables of the environment of the 3D imager chosen among: the background light, the ambient temperature, the average luminosity, the local time, the detection of day and night, the absolute or relative speed of a target, the spectral characteristics of the target or a combination of them.

In an embodiment said time window TW is generated by a pulse shaper block.

In an embodiment said time window TW is defined as an electrical gating signal.

In another aspect the invention is achieved by a 3D imaging sensor, defined also as 3D imager, for determining the 3D image of scene or a target. The 3D imaging sensor comprises:
a sender device, comprising a light source configured for emitting, at a start time T0, a light pulse;
a receiver device, comprising a detector comprising a plurality of detector elements for detecting incident photons,
the receiver device being configured for detecting a first incident photon and for extracting the time of incidence T1 of said first incident photon,
the receiver device being configured for. opening, at said time of incidence T1, a time window TW having a predetermined duration of time ΔT,
the receiver device being configured for detecting, during said time window TW, further incident photons by said plurality of detector elements and for identifying the individual detector elements that have detected said further incident photons,
the receiver device being configured for associating, during said time window TW, to each of said individual detector elements said time of incidence T1,
the receiver device being configured for extracting the time interval T1−T0, the receiver device being configured for repeating the opening and closing of successive time windows TW at the incidence of first incident photons.

In an embodiment the 3D imaging sensor comprises a time-to-digital converter, a time window generator, a memory.

In an embodiment wherein the time-to-digital converter comprises a clock source as a time reference for the time conversion, and a latch.

In an embodiment said time window generator comprises a pulse shaper block.

### BRIEF DESCRIPTION OF THE DRAWINGS

The present invention will now be described in reference to the enclosed drawings where:

FIG. 1 is a schematic cross-section view of the Time-of-Flight system of the invention;

FIG. 2 shows a typical TCSPC histogram obtained, under low background light, by a 3D imaging sensor that is a flashed LIDAR;

FIG. 3 shows a typical TCPSC histogram obtained, under strong ambient light, by a flashed LIDAR imager affected by the presence of a mild pile-up effect;

FIG. 4 shows another typical TCPSC histogram obtained, under very strong ambient light, by a flashed LIDAR imager saturated by the presence of a strong pile-up;

FIG. 5 illustrates schematically the different blocks of a 3D imager of the invention;

FIG. 6 illustrates first incident photons that define successive time windows and the association of detected photons in the time windows to timestamps for each time window;

FIG. 7 shows a schematic link of the different electronic blocks of the 3D imager of the invention;

FIGS. 8 and 9 show embodiments of configurations of the electronic blocks of the 3D imager of the invention.

### DETAILED DESCRIPTION

The present invention will be described with respect to particular embodiments and with reference to certain drawings, but the invention is not limited thereto. The drawings described are only schematic and are non-limiting. In the drawings, the size of some of the elements may be exaggerated and not drawn to scale for illustrative purposes. The dimensions and the relative dimensions do not correspond to actual reductions to the practice of the invention.

It is to be noticed that the term “comprising” in the description and the claims should not be interpreted as being restricted to the means listed thereafter, i.e. it does not exclude other elements.

Reference throughout the specification to “an embodiment” means that a particular feature, structure, or characteristic described in relation to the embodiment is included in at least one embodiment of the invention. Thus, appearances of the wording “in an embodiment” or, “in a variant”, in various places throughout the description, are not necessarily all referring to the same embodiment, but several. Furthermore, the particular features, structures or characteristics may be combined in any suitable manner, as would be apparent to a skilled person from this disclosure, in one or more embodiments. Similarly, various features of the invention are sometimes grouped together in a single embodiment, figure, or description, for the purpose of making the disclosure easier to read and improving the understanding of one or more of the various inventive aspects. Furthermore, while some embodiments described hereafter include some features included in other embodiments, combinations of features of different embodiments are meant to be within the scope of the invention, and from different embodiments. For example, any of the claimed embodiments can be used in any combination. It is also understood that the invention may be practiced without some of the numerous specific details set forth. In other instances, not all structures are shown in detail in order not to obscure an understanding of the description and/or the figures.

In the present document further terms are defined:

The 3D imaging sensor of the invention is also defined as a 3D imager and may be a LIDAR. A LIDAR herein may be a flashed LIDAR which is a LIDAR that relies on illuminators which illuminate the entire detector field of view at once, i.e. without relying on optical scanning configurations.

“Background light”, or “background” is defined broadly as unwanted or useless light—or noise—that reaches a detector or detector array of a 2D, a 3D or a hybrid 2D/3D imager of an imaging system. Otherwise said, the term background comprise all detectable signals that are not correlated with the signal of interest of an imaging system. In the context of this invention, the main source of background is typically ambient natural or artificial light. Background light may be narrow band light or broadband light. Narrow band background light may be light coming from another light source than the light source of an imaging system. Broadband light may be sunlight or any perturbating light that has a broad spectrum such as provided by a bright light source such as a streetlight or the like.

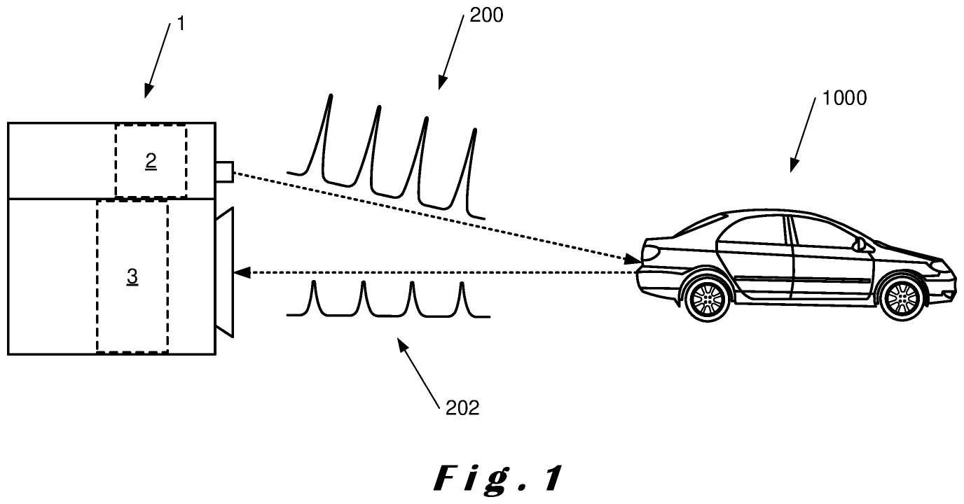

In the context of this invention, a “signal of interest” is defined as a light signal to be detected, preferably a light pulse (more generally, an electromagnetic wave) generated by an emitter, usually a laser, laser array, LED, or LED array, located in most cases, but not exclusively, in the vicinity of the detector. In a typical application of the imager of the invention, a light pulse travels to the scene in front of the detector, is diffused back, and is imaged onto the detector of the imaging device. A “detector” according to the invention is the part of the 3D imaging system that detects and measures the light pulse. In LIDAR applications, illustrated in FIG. 1, the detector produces a response that can be used to infer the time of arrival of the electromagnetic wave onto the sensor surface. The detector of the invention comprises an array of detector elements. Not all detector elements have to be identical.

A detector event, also defined as a pixel event, is the detection of an incident photon by a detector element and the subsequent generation of its detection signal.

A timestamp is a digital representation of the time of occurrence of a detection event.

The terms “scene” and “target” are defined broadly. A scene may be far-field obstacles such as the shape of a road or the presence of buildings or trees. A target is a term more used for predetermined objects, such as a car to which the distance and its variation has to be monitored. A target may also be a mm or a sub mm shaped objects such as biomolecular substances which 3D shape has to be determined. Targets must not be necessarily moving targets. A target may also be a mechanical structure which 3D shape has to be determined. The mechanical structure may be for example a moving element in a mechanical or industrial process.

The invention relates in particular to 3D image sensors wherein furthermore a large number of detectors have to operate simultaneously and at a very high speed. The number of detector elements may be greater than 10000 or greater than 20000. The frame rate for the generated image may be greater than 30 fps.

This invention relates to LIDAR imagers and 3D imagers in particular, wherein a time-correlated signal of interest needs to be detected over a background level that can have an intensity several orders of magnitude larger. The 3D imager of the invention may provide information on the distance together with an image of the target and also on the distance and at the same time on the 3D profile of the surface, or a portion of it, of a target.

### Time-Correlated Single-Photon Counting (TCSPC)

In this section general aspects of photon detection by Time-Correlated Single-Photon Counting (TCSPC) are addressed.

By recording the time of emission of the electromagnetic wave by the emitter, the detector of a 3D imager or LIDAR can calculate the round-trip-time of the traveling electromagnetic wave, known as the Time-of-Flight (TOF).

A specific implementation of this measurement technique, called Time-Correlated Single-Photon Counting (TCSPC) uses:
pulsed lasers emitted by an emitter,
single-photon detectors (SPADs) in the pixels of an imager, and
Time-to-Digital Converters (TDCs) in the readout path.

In a typical TCSPC implementation, provided here as an example, the TDCs are configured to start synchronously to the emission of a laser pulse that is flashed upon a scene or a target. The laser pulse interacts with the scene or the target and is back-reflected or back-scattered and returns to the 3Dimager, albeit greatly attenuated, where it is detected by the detector arrays, typically SPAD detector elements, defined as pixels of the detector. As soon as the SPAD pixel detects a photon, a corresponding detection signal is emitted, the TDC conversion is stopped, and a digital representation of the time interval between start and stop is accumulated into memory.

Given that it is impossible to predetermine the cause of the SPAD pixel event (ambient light, pulse light, and dark noise), it is necessary to repeat the same measurement several hundreds to several thousands of times in order to extract useful statistical metrics out of the data. Ambient light and dark noise are substantially uniformly distributed in time, while signal photons are correlated in time with the emission of the laser and the start point of the TDCs. When plotted in a histogram, the extracted time will present in the histogram a noisy plateau corresponding to the detection of ambient light photons and dark noise, superimposed on a narrow peak corresponding to the time-correlated signal photons.

In the presence of a situation or scene with strong background, a detector such as the one described in the previous paragraph is unable to perform a measurement of the signal of interest due to the phenomenon called pile-up, i.e. the detector will be saturated by background events, and left unable to respond to the signal of interest. Pile-up is related to the probability of each pixel to detect a photon at each moment in time. If ambient light intensity is low, then the probability of detecting a photon is also much less than unity, defined as the photon-starved regime. In this regime, the probability of detecting a photon while no photon has been detected before is high across the entire measurement range, therefore background light accumulates in the histogram in a quasi-uniform fashion. If background gets very strong, the probability of detecting a photon when no other photon has been detected before decreases significantly in time. In other words, as soon as the pulsed light source emits a light pulse laser, in a standard configuration as known from prior art, a pixel (i.e. a light sensitive element of a detector array) is made sensitive, there is a large chance that an ambient photon will trigger the sensors. The histogram will then show an accumulation of events close to the beginning of the measurement range, and little to no useful signal.

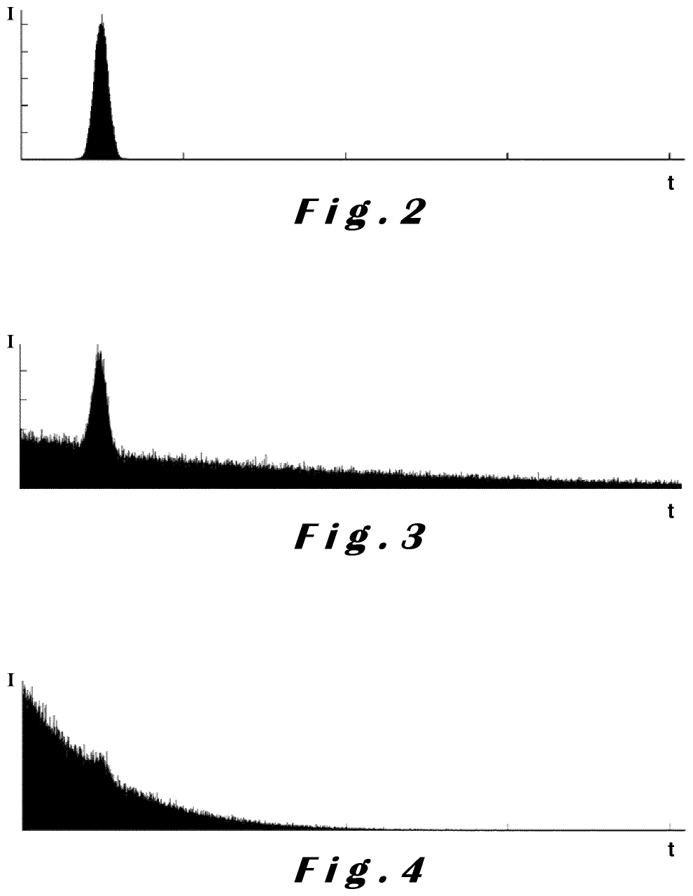

As an example, FIGS. 2 to 4 illustrate 3 different cases obtained by the hereabove presented TCSPC system. The 3 cases present the simulated results as a function of the level of the background light level and for a laser peak power of 5 W. It should be noticed that due to the pile-up not only the shape of the readout is affected, but also the peak of the detected signal decreases exponentially, eventually making it impossible to distinguish signal from noise.

FIG. 2 shows a TCSPC histogram, obtained under 0 LUX background light.

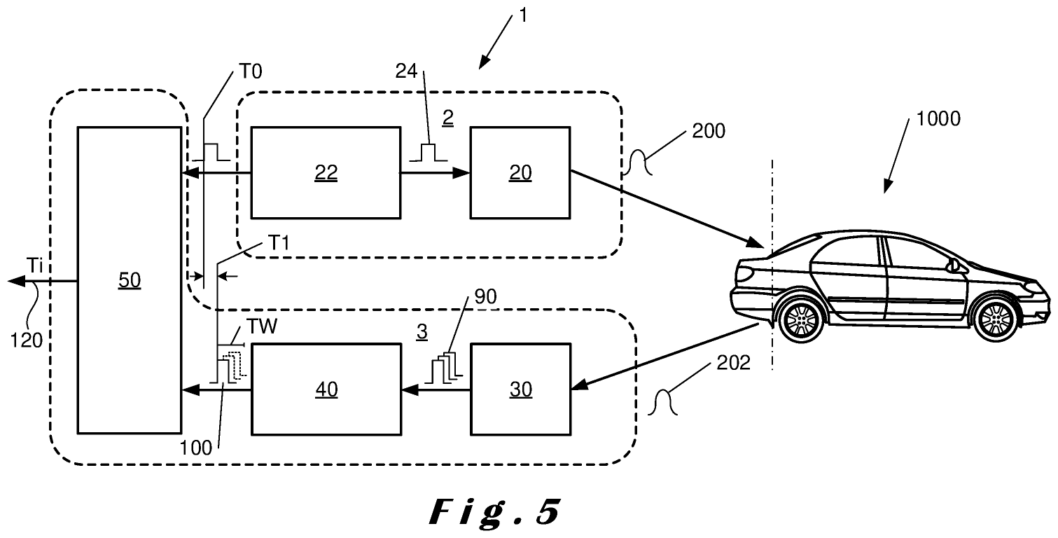

FIG. 3 shows a TCSPC histogram, obtained under strong ambient light of 1 kLUX.

FIG. 4 shows another TCSPC histogram, obtained under very strong ambient light of 10 kLUX.

### Detailed Description of the Method and 3D Imager of the Invention

The present invention overcomes the limitations of prior art methods and devices to realize distance and 3D measurements of a target or a scene. The following sections will describe more precisely the method and the device 1 of the invention.

FIG. 1 illustrates the 3D imager 1 of the invention in a situation wherein a distance and 3D information of a target 1000 has to be determined, the 3D information comprising the distance of multiple points of a target 1000 or a scene. The signal of interest is a light pulse (more generally an electromagnetic wave pulse) generated by an emitter 20, usually a laser, laser array, LED, or LED array, located in the vicinity of the detector. The light pulse 200 travels to the scene or target 1000 in front of the detector 30, is diffused back, and is imaged onto the detector 30. As schematically illustrated in FIGS. 1 and 5, the detector 30 measures the back-reflected light pulses 202 and produces a response that can be used to infer the time of arrival T1 of the electromagnetic wave onto the sensor surface.

By recording the time of emission of the electromagnetic wave by the emitter 20, the detector 30 can then calculate the round-trip-time of the traveling electromagnetic wave, known as the Time-of-Flight TOF.

The proposed invention makes use of a continuously running TDC to extract the time information of incoming photons. Differently from the START/STOP mechanism of prior art devices, the TDC of this invention is never stopped, allowing the generation of multiple timestamps within the same laser cycle. Not being limited to the detection of only the first event, this architecture results in being immune to pile-up saturation effects, guaranteeing an efficient sharing of the TDC among multiple pixels and therefore allowing for a better scalability of the detector array.

In a specific implementation of the proposed system 1, the time to digital converter device acts similar to a chronometer whose time is saved every time a photon is detected. Contextually to the activation of the light emitter 20, the time of the emission of the light source is also saved and used as reference for all the upcoming detected photon events.

A single time to digital converter is connected to multiple detectors and is used to extract the time of activation of any of the connected detectors. Together with the activation time, an identification code ID of the detectors that have activated the TDC is also saved. The identification code ID is associated with the extracted time signal. The association between the arrival time and the activated detector pixel (i.e. the signal emitting detector element), allows to maintain the correlation between the detected distance of a target area and the local area of the detector array in which such event has been detected. Therefore, the granularity of the detectors is maintained even when multiple pixels share the same TDC. The target area and the local area of the detector array may be very small areas. For example, a target area of 20 cm×20 cm at a distance of 50 m would be imaged on a 20×20 μm area on the detector surface.

In the TCSPC measurement the evaluation of the target distance is linked to the detection of the back-reflected laser photons. Due to the physical nature of the laser pulse, the emitted travelling light is characterized by a packet of photons concentrated in a very short interval of time, usually in the order of ns. It is very likely that when such pulses are received by an array of single photon detectors, several of its detector elements get triggered by photons of the same pulse, providing different detection events within a very short time interval (<1˜2 ns). On the contrary, in the case of noise or background light events the probability of triggering multiple detectors in a short time is smaller. Being able to detect events coming in short intervals therefore translates into a higher SNR for the system.

The present invention provides an innovative technique to cope with photon events that are detected within a very short time interval and which are produced by detectors sharing the same TDC. This is totally different than what happens in any other prior art solution. In prior art devices very close events, i.e. in function of time, are discarded with a consequent signal loss for the reconstructed image. The method and 3D imaging sensor 1 of the invention allow the extraction and further elaboration of events that are very close to each other in function of time.

The problem is solved by the method and 3D imaging sensor of the invention due to the implementation of an electrical gating signal (hereinafter referred to as time window) introduced between the detector 30 and the time-to-digital converter TDC.

When a first photon is received by the detecting device 3, its time of arrival is registered together with the ID of the detecting element. Consequently, to the detection of this first photon, a time window TW having duration ΔT is generated. For all the upcoming photons detected during said time window TW, only the identification code ID of the detector that has generated a signal is saved. These detectors are then associated with the time of the first event of the time window TW, which is the one that opens said time window TW. All the detector elements that sense a photon during an opened time window TW, are treated as if these detector elements were detecting a photon at the opening time of the same time window TW.

More precisely the method of the invention for determining 3D information of a target 1000, comprises the steps of:
A. providing a 3D imager 1, illustrated in FIGS. 1 and 5, comprising a sender device 2 including a light source 20, and a receiver device 3 including a detector 30 comprising a plurality 30′ of detector elements 32;
B. activating said sender device 2 and emitting, at a start time T0, a light pulse 200;
C. detecting a first incident photon by one of said detector elements 32;
D. extracting the time of incidence T1 of said first incident photon;
E. opening, at said time of incidence T1, a time window TW having a predetermined duration of time ΔT;
F. detecting, during said time window TW, further incident photons by said detector and identifying the individual detector elements that have detected said further incident photons;
G. associating, during said time window TW, to each of said individual detector elements that have detected said further incident photons, said time of incidence T1, and closing said time window;
H. extracting the time interval defined by T1−T0.
I. Repeating steps C to H by detecting at each cycle a new first incident photon.
J. Repeating the steps B-I.

In an embodiment the method comprises a step K of providing a 3D image of said target 1000 by using the information, provided during said time window TW, of said time of incidence T1 associated to each of said individual detector elements.

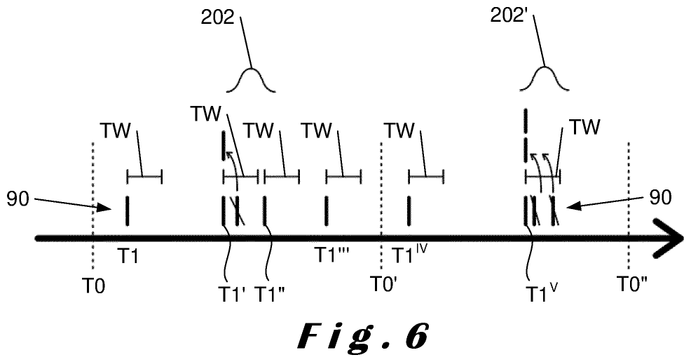

FIG. 6 illustrates two cycles of activation of the laser emission, i.e. steps B to G. Laser pulses are emitted a time T0 and T0′. At time T0 the sender 20 is activated, the time T0 is extracted by the time to digital converter and the information of the time T0 saved in a memory. Any photon that is received by the detector element, within the time frame between T0 and T0′, will have as time reference the event of the previous laser emission T0, meaning that the time T0 will be subtracted by each time T1ⁱ extracted by the TDC in such time frame.

In the example of FIG. 6 the pulse 202 represents the laser pulse received by the detector 30 after being reflected by a target 1000. All the events that are detected outside the pulse 202 are considered as noise events.

FIG. 6 illustrates how at the time of incidence of a first photon a time window TW is started. In the example of FIG. 6, during the opening time ΔT of the first time window TW, no additional photons are detected by the detector array 30′. Therefore, in the illustrated first time-window TW in the example of FIG. 6, the extracted time of the first event T1 is associated uniquely to the pixel, i.e. detector element, that has generated it. When another photon is detected by any other detector element 32 of the array 30′ of detectors again a time window TW is opened at the time T1′.

In the example illustrated in FIG. 6 a further incident photon is detected during the time window TW following the start time T1′. The detection of said further incident photon may be made by any one of the detector elements of the array 30′. In this case the time T1′ is associated both with the detector element that has generated it and also with the detector element that has produced the event falling in the opened time window TW. FIG. 6 also illustrates that, at another time T1^{v}, a fifth time window TW is opened and 3 incident photons, detected within the time window TW, are associated to the timestamp produced by T1^{v} in said association step G. The value T1^{v} is then saved in a memory and the value of T0′ will be subtracted by T1^{v} in a step H. The system 1 is configured so that the detector elements that have detected incident photons are identified and that the information of their identification is stored in a memory 60.

By identifying the different detector elements that have been associated to the different timestamps, it is possible to determine 3D information on a target 1000, such as its distance, its speed, but also possibly the 3D shape of a target and/or or its orientation of movement as well. The 3D information of the target is derived in a further elaboration step, and it is based on the multiple values Ti that are extracted in the process from the activation steps B to the extraction of time, i.e. steps H.

The 3D image of a target or 3D image reconstruction of a given portion of space, is generated by evaluating the distance of multiple points of the scene, where each of the reconstructed points corresponds to the projection of the scene onto one of the pixel of the 3D image sensor. During the step H, the system saves the time difference T1−T0 for all the detector elements that have received a valid photon. By repeating these steps many times, usually several thousands of times, the saved data will be used to build up a histogram for each of the detector elements of the detector array 30′. Elaborating the histograms obtained for each of the detector elements, the time of flight information of the reflected laser can be extracted and eventually the distance of each of the points of the scene or target corresponding to a given detector element 32 can be reconstructed.

In an embodiment, the detector elements 32 are single photon detection elements, such as single photon avalanche diodes (SPAD).

In an embodiment, said light source 20 is a pulsed laser. The invention is not limited to the use of lasers and other pulsed light sources may be used. Also, the light pulses may be provided by a continuous light source in front of which a light modulator may be arranged.

In an embodiment, the method comprises an additional step of activating a predetermined number N of detector elements 32 of said detector 30. For example, only 50% of the detector elements may be configured to provide a signal. Such an embodiment allows to adapt dynamically the field of view. Also, it allows to reduce power consumption by switching off certain detectors.

It is also possible to generate a 3D image of a smaller part of the scene/target, i.e.: area of interest. Furthermore, it allows to adjust dynamically the focus of an image by reducing or increasing the number of active detector of a certain area.

In an embodiment, said time window TW is applied only to all of said predetermined number N of detector elements 32.

In an embodiment, the time duration ΔT of the time window TW may be changed during any one of steps A-I. This allows to dynamically adjust the system performances. For example, in the detection of a close target, the light reflected towards the sensor has a much higher intensity and there is a very high probability that multiple photons are received in a short time. In this case a larger window increases the detected signal and SNR. When the obstacle is far, the window can be reduced to speed up the computation. The window duration ΔT can change according to the emitted laser pulse width. If the laser pulse increases, the window TW can be increased accordingly to be able to catch multiple photons from the same pulse.

In variants, the time duration ΔT of the time window TW may be changed during any one of steps A-I according to a predetermined time scheme before the first emission of a laser pulse 200.

In an embodiment, the method comprises a step to define the duration ΔT of the time window TW depending on internal or external conditions.

In an embodiment, the method comprises a step to define the maximal number of incident photons that may be registered during said duration of time (ΔT).

In an embodiment, the definition of said maximal number of incident photons may be changed during any one of steps A-I.

In an embodiment, the definition of said maximal number of incident photons is defined by internal or external conditions. Such “internal conditions” are defined as conditions depending on variables that are internal to 3D imager devices and could be modified by acting on some device parameters. A list of possible variables, but not limited to, defining internal condition may possibly be: power consumption activity of detector matrix, the temperature of the imager device, duration of the laser impulse, number N of active detector elements or any combination of them. The activity of said active detector elements is defined as the rate of detected photons per unit of time per detector element.

Said “external conditions” are defined as conditions depending on variables that are given by the operating environment and cannot be intentionally modified. A list of possible variables, but not limited to, defining external condition can be: the background light, the ambient temperature, the average luminosity, the local time, the detection of day and night, the absolute or relative speed of a target 1000, the spectral characteristics of a target 1000 or any combination of them.

In an embodiment, a controller device can be implemented for regulating the duration of the time window TW and the maximum number of accepted photons according to the detector activity. For example, a dedicated pixel of the array can be used for counting the average number of photons that are detected during a time window TW. A controller could apply pre-set positive and negative variations on top of the average time of the window duration. If increasing the time window duration, increases the number of detected events, the controller could increase the average duration of the window of a given pre-set value to acquire more signal and improve the SNR. On the contrary, if increasing the window duration ΔT does not increase the number of detected events, the controller could decrease the average duration of the window of a given pre-set value to speed up the computation.

In an embodiment, said time window TW is generated with a pulse shaper block.

In an embodiment, the 3D imager activates only a predetermined number of detectors at a time.

### The 3D Imaging Sensor 1 of the Invention

This invention relates in particular to image sensors and LIDAR imagers in particular, where a large number N of detectors. operate simultaneously.

In embodiments, N may be larger than 1000, or larger than 2000, even larger than 5000 or even larger than 10000.

Furthermore, the 3D imaging sensor can be required to operate at a frame rate higher than 30 fps (frames per second), and a signal of interest needs to be detected over a background level that can be several orders of magnitude larger than the detected photons provided by the flashlight source.

The 3D image in a TCSPC needs a large number, i.e. several thousands, of detection cycles before producing an image. Said imaging timescales (frame per second), refers to the speed of the generation of a 3D image. For example, 30 fps means that 30 3D images per second are provided as output of the 3D imaging sensor 1. The frame rate does not always need to be higher than 30 fps, but this is a requirement in certain typical applications as for example the automotive one.

The 3D imager 1 is configured to execute all the steps as described in the method section as described herein. More precisely, the 3D imaging sensor 1 allows to determine a range and/or provide 3D information from a target 1000, and comprises:
a sender device 2, comprising a light source 20 configured for emitting, at a start time T0, a light pulse 200;
a receiver device 3, comprising a detector 30 comprising a plurality 30′ of detector elements 32 for detecting incident photons. The photon-detector elements 32, referred to as pixels, are connected individually or in group to an electronic chronometer device, referred to as TDC.

The receiver device 3 is configured for detecting a first incident photon and for extracting the time of incidence T1 of the detection of said first incident photon.

The receiver device 3 is configured for opening, at said time of incidence T1, a time window TW having a predetermined duration of time ΔT. The receiver device 3 is configured for detecting, during said time window TW, further incident photons by said plurality 30′ of detector elements 32 and for identifying the individual detector elements that have detected said further incident photons.

The receiver device 3 is further configured for associating, during said time window TW, to each of said individual detector elements 32 said time of incidence T1. Furthermore, the receiver device 3 is configured for extracting the time T1−T0, and is further configured for repeating the opening and closing of successive time windows TW, whenever after the closing of a time window TW, a new first incidence photon is received by the detector array.

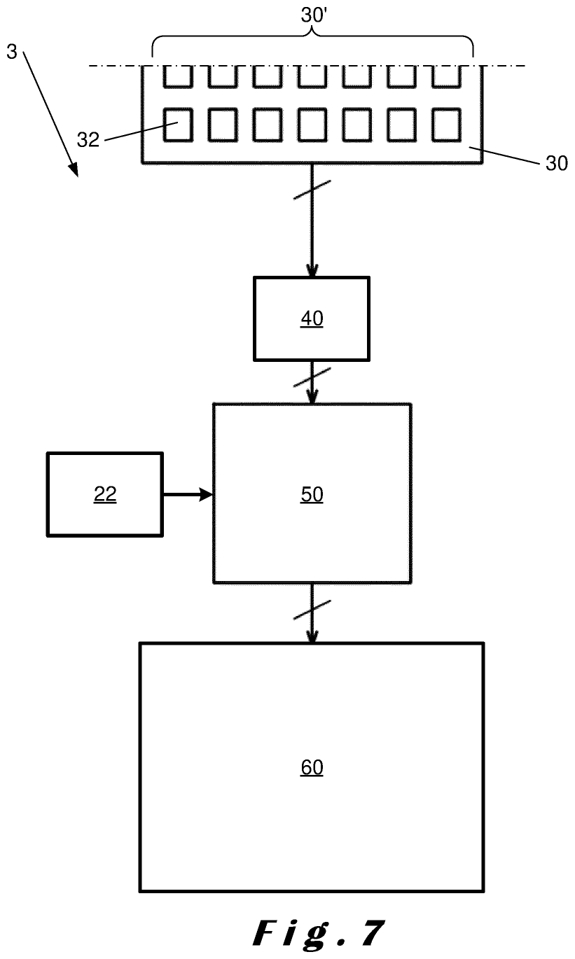

FIG. 7 illustrates the basic layout of the receiver device 3. The detection device 3 of the 3D imager 1 comprises:
a time to digital converter 50 (TDC),
a time window TW generator 40,
a memory 60 for storing timestamps as described herein.

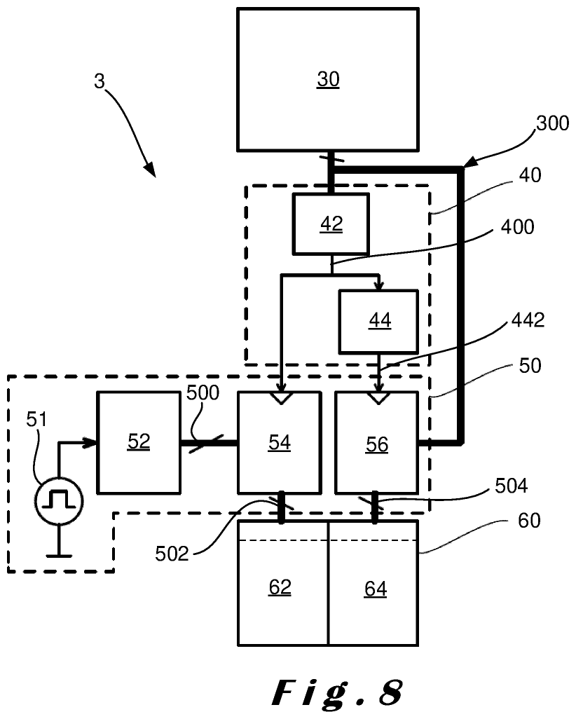

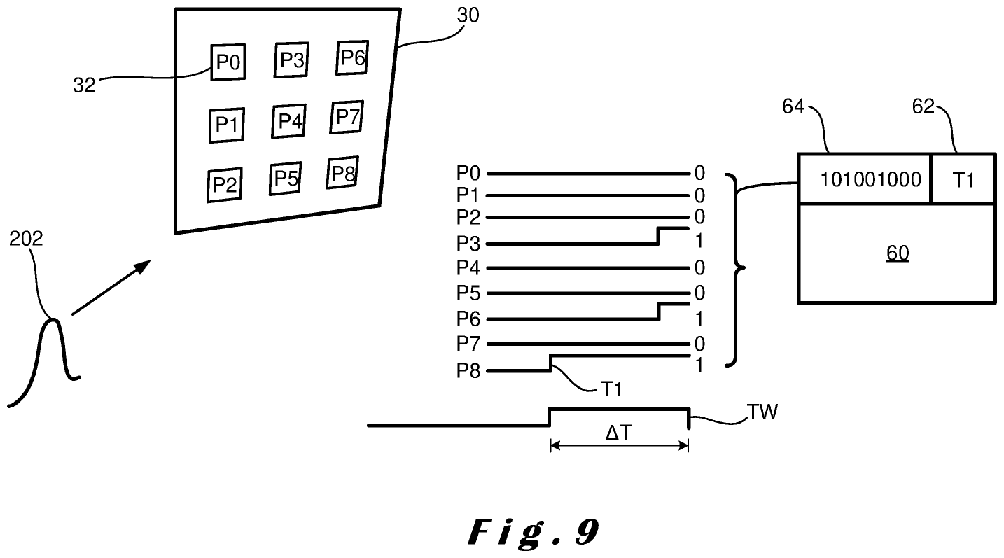

FIG. 8 shows an embodiment of an exemplary layout of the different blocks of the receiver part 3 of the 3D imager 1 and comprises (1-11):
1) a detector 30 comprising a detector array 30′ of detector elements 32;
2) a time window TW generator block 40, comprising an electrical detection block 42 for the detection of a first input event and a pulse shaper 44 which is an electronic block configured for generating said time window TW;
3) an output detection signal 400 from the electrical detection block 42 provided at the detection of a first event by 42. The signal provided by said output 400 is provided to a latch 54, as described further, and pulse shaper block 44 to generate a signal 442 corresponding to the time window TW of duration ΔT;
4) a time to digital converter 50 comprising a clock source 51 and a time converter block 52, described in detail further herein;
5) an electrical signal 500 proportional to time t;
6) a set of wires constituting a signal bus 300 to provide detection signals, one for each of the detectors of the array;
7) a system of latches 54,56 comprising a first latch 54 configured for registering the current time t;
8) the system of latches 54, 56 comprising a second latch 56 configured for registering the detection signals;
9) a digital signal representing the extracted time 502 which is said timestamp.
10) a digital signal 504 containing the ID of which detector element has detected an event.
11) a memory 60 comprising a memory allocation part 62 for providing a timestamp and a memory allocation part 64 for providing said identification code ID.

In embodiments, the system 1 may comprise a frequency generator that may be a Phase-Locked-Loop (PLL), a Voltage Controller Oscillator VCO or a frequency signal may be provided by an external signal source.

FIG. 8 shows an exemplary implementation of the receiver 3 of the said 3D imager and is described in detail in the following.

The receiver 3 is configured to measure the arrival time of the detected photons of an incident light beam 202, and to compare these times of detected photons to the time of emission of the laser pulse 200. The time conversion is realized similar to a chronometer. The receiver device 3 embeds a clock 51 that is a continuously running clock, and whose clock time is saved in said memory 60 every time that a photon is detected by the detector 30, and elaborated by the window time generator block 40 as explained in the following.

The time converter block 52 converts an input “time information” to an electrical quantity, such as a charge, a voltage, a current. Said “input time information” may be the rising edge of an input clock signal 51 and the time converter 52 can be realized in different ways, such as a digital counter, charging/discharging capacitors or by phase interpolation.

The electrical signal 500 proportional to time t thus corresponds to an electrical quantity whose value is proportional to time. Whenever a time needs to be extracted from the chronometer, the electrical signal 500 is latched in the latch 54 and is then accumulated into said memory 60.

Each of the detector elements 32 of the array 30 is connected to an individual wire, the ensemble of these wires is represented in FIG. 10 with said signal bus 300.

Whenever one of the detectors receives a photon, an electrical detection signal is activated on the wire of the corresponding detector element 32. The electrical detection block 42, which might be realized with a bank of edge-sensitive flip-flops, is used to detect the first of the detection events that might be triggered at its input on the bus 300.

After the detection of a first input event by said electrical detection block 42, a signal provided by said output 400 is passed through said pulse shaper block 44 to generate a signal 442 (FIG. 8) representing the time window TW of duration ΔT. Contextually, the same signal 400 is received by the time to digital converter 50, and activates the latch 54 to save the current time provided by the time signal 500. This time corresponds to the time of the first event T1.

While only the first of the detection events of the bus 300 is used by time to digital converter 50 to extract the time of arrival T1, the other detection events that might arise due to detection from any other of the elements of 30, are provided as input to the latch 56 of the time to digital converter, configured for registering the detection signals. The latch 56 is a block that might be realized with a bank of level sensitive flip-flops, registers the detection events of 300 that are triggered during the active time of the time window TW.

The signals 504 produced by the latch 56, are used to identify which of the detector elements 32 have detected a photon during the time window TW. This information, which corresponds to an ID identifying the emitting pixel of the detector 30, is saved in a memory 60 together with the extracted time T1, here represented with the extracted time signals 502.

The memory 60 is divided into two different allocation sectors, a first sector 62 being a memory bank for the extracted time, and a second sector 64 being a memory bank for the identification code IDs of the detector 30 that have received the photons.

Here, an extracted time is uniquely associated to an ID, by creating a one-to-one relationship from the position of the two sectors 62, 64.

FIG. 9 illustrates in detail how in the 3D imager 1 the detected time of arrival of a first incoming photon gets associated with the identification code ID of all the detector elements 32 that receive a signal during the activation of the time window TW.

In the reported example of FIG. 9, the detector array 30′ is composed of 9 single photon detector elements 32, enumerated from P0 to P8. In the FIG. 9 the label P8 to P0 is used for both the detectors and their associated digital signals, represented by the binary signal lines of the adjacent time diagram. When any of these detector element senses a photon, its corresponding signal gets asserted.

In FIG. 9 is represented also an example of a typical evolution of these signals over time. The pulse 202 represents the laser pulse reflected from a target 1000 and received by the detector 30.

FIG. 9 represents schematically the case of a first photon that is detected by the detector P8. Following the detection of this first detection event, a time window TW is activated and the time of arrival T1 is extracted. During the opening time ΔT of the window TW, detectors P6 and P3 also sense a photon and their corresponding signals get asserted.

The value of the signals P8 to P0 that have been asserted during the time window TW, corresponding to the series of numbers 0 and 1 represented at the end of the time window, gets saved at the closing of this window into a memory bank 64. The digital code 101001000 corresponds to the ID of the detecting pixels and is used to assess which detecting element has produced an event among the plurality of detectors. The extracted time T1 is also saved and stored into another memory bank 62. These two memory registers 62, 64 are associated in an one-to-one relationship, meaning that the detectors P8, P6 and P3 will be treated as if they have all detected a photon at time T1.

The described imager can be considered as an independent structure or it can be repeated in an array fashion to build a full matrix of imagers.

In an embodiment, the pixel group of each independent imager can be realized following a column-wise grouping of a bigger pixel matrix.

In an embodiment, the pixel group of each independent imager can be realized grouping adjacent or non-adjacent pixels following any arbitrary geometry.

In embodiments, the full matrix of detector 30 comprises a plurality of similar or identical independent imagers, each imager having possibly more than 100 detector elements, possibly more than 1000 detector elements, possibly more than 10000 detector elements, or even more than 20000 detector elements. Not all detector elements 32 must be identical detector elements.

In variants, the detector 30 may be composed of at least two different detector arrays. For example, one detector array may be configured to be sensitive to a first spectral range and another detector array may be more sensitive to another spectral range.

In variants, the 3D imager may comprise optical active elements or components such as optical shutters or modulators in order to improve the performance of the 3D sensor.

In embodiments, the 3D imager may comprise a calibration module.

In an embodiment, the receiver device 3 comprises at least one photon avalanche detector (e.g. SPAD).

In an embodiment, the 3D imager embeds microlenses to improve the pixel photon probability detection.

In an embodiment, the detector elements 32 may comprise a coating on their surface to filter out the unwanted background light from the laser light.

In an embodiment the detector array and the time to digital converters are realized in two different chips and are stacked one on top of each other in a 3D-stack arrangement.

1. A method of determining 3D information of a target, the 3D information comprising the distance of multiple points of said target, the method comprising the steps of:
A. providing a 3D imaging sensor comprising a sender device comprising a pulsed light source, and a receiver device comprising a detector comprising a plurality of detector elements;
B. activating said sender device and emitting, at a start time, a light pulse;
C. detecting a first incident photon by one of said detector elements;
D. extracting the time of incidence of said first incident photon;
E. opening, at said time of incidence, a time window having a predetermined duration;
F. detecting, during said time window, further incident photons by said detector and identifying the individual detector elements that have detected said further incident photons;
G. associating, during said time window, to each of said individual detector elements that have detected said further incident photons, said time of incidence, and closing said time window
H. extracting the time interval Ti defined by T1−T0.
I. Repeating steps C to H by detecting at each cycle a new first incident photon.
J. Repeating the steps B to I.

2. The method according to claim 1, further comprising a step K of providing a 3D image of said target by using the information, provided during said time window, of said time of incidence associated to each of said individual detector elements.

3. The method according to claim 1, wherein the detector elements are single photon detection elements.

4. The method according to claim 3, wherein the single photon detection elements are single photon avalanche diodes.

5. The method according to claim 1, further comprising a step of activating a predetermined number N of detector elements of said detector.

6. The method according to claim 5, wherein said time window is applied only to all of said predetermined number N of detector elements.

7. The method according to claim 1, comprising a step to define the maximal number of incident photons that may be registered during said duration.

8. The method according to claim 7, wherein the definition of said maximal number of incident photons may be changed during any one of steps A-J.

9. The method according to claim 7, wherein the definition of said maximal number of incident photons is depending on internal or external conditions.

10. The method according to claim 1, wherein said predetermined duration may be changed during any one of steps A-J.

11. The method according to claim 10, wherein the change of duration is depending on internal or external conditions.

12. The method according to claim 11, wherein said internal conditions are variables of the 3D imager chosen among: the power consumption, the activity of the detector matrix, duration of the laser impulse, the temperature of the imager device, or a combination thereof.

13. The method according to claim 11, wherein said external conditions are variables of the environment of the 3D imager chosen among: the background light, the ambient temperature, the average luminosity, the local time, the detection of day and night, the absolute or relative speed of the target, the spectral characteristics of the target or a combination thereof.

14. The method according to claim 1, wherein said time window is generated by a pulse shaper block.

15. The method according to claim 1, wherein said time window is defined as an electrical gating signal.

16. A 3D imaging sensor for determining a range to a target comprising:
a sender device, comprising a light source configured for emitting, at a start time, a light pulse;
a receiver device, comprising a detector comprising a plurality of detector elements for detecting incident photons,
the receiver device being configured for detecting a first incident photon and for extracting the time of incidence of the detection of said first incident photon,
the receiver device being configured for. opening, at said time of incidence, a time window having a predetermined duration of time,
the receiver device being configured for detecting, during said time window, further incident photons by said plurality of detector elements and for identifying the individual detector elements that have detected said further incident photons,
the receiver device being configured for associating, during said time window, to each of said individual detector elements said time of incidence,
the receiver device being configured for extracting the time interval Ti being equal to T1−T0, the receiver device being configured for repeating the opening and closing of successive time windows at the incidence of first incident photons.

17. The 3D imaging sensor according to claim 16, comprising a time-to-digital converter, a time window generator, a memory.

18. The 3D imaging sensor according to claim 17, wherein the time-to-digital converter comprises a clock source as a time reference for the time conversion, and a system of latches.

19. The 3D imaging sensor according to claim 16, wherein said time window generator comprises a pulse shaper block.
